(19) United States
(12) Patent Application Publication
(10) Pub. No.: US 2009/0158587 A1
(43) Pub. Date: Jun. 25, 2009

(54) HEAT-BASED REDIMENSIONING FOR REMANUFACTURE OF FERROUS COMPONENTS

(75) Inventors: Marvin Grendel McKimpson, Metamora, IL (US); Narendra Pal Singh, Peoria, IL (US); Candice A. Lundy, Peoria, IL (US); Michael Lynn Johnson, Lacon, IL (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: CATERPILLAR INC., Peoria, IL (US)

(21) Appl. No.: 11/960,377

(22) Filed: Dec. 19, 2007

(51) Int. Cl. B23P 6/00; C21D 8/00

(52) U.S. Cl. 29/888.011; 148/579; 72/364

(57) ABSTRACT

A system and method of redimensioning a ferrous object includes applying a localized heat source to a portion of the object and raising the portion to a temperature sufficient to cause a local expansion via the formation of martensite. Subsequently, the object is quenched while in a locally expanded state to cause a selective expansion of the object that persists at room temperature. The object may be cast iron or hardened steel in an embodiment. In a further embodiment, heat is applied via an inductive heater. In an embodiment the method includes machining the object after quenching.

### TECHNICAL FIELD

This patent disclosure relates generally to the remanufacturing of metallic machine parts and, more particularly to the redimensioning of ferrous components for remanufacturing.

### BACKGROUND

Many machine parts intended for high-stress environments are made of ferrous materials such as iron and various types of steel. These materials tend to be structurally strong, relatively heat resistant, and resistant to most chemicals such as the petrochemicals used in many fueling and lubrication applications. However, the high-stress usage environments for these materials may eventually lead to a certain amount of material wear and degradation of machine parts. For example, a steel crankshaft may experience wear to the point that it fails to meet the relevant specification, e.g., it fits too loosely within the associated crankshaft bearings or bushings. Similarly, an iron piston liner may be eroded through use, to the point that the gap between the liner and an associated piston or piston ring is excessive, leading to exhaust blow-by, loss of compression, and other issues.

Typically, it is difficult to repair such a part. Instead, one option for the remanufacture of such a part is to add new material to the part and then machine the part back into tolerance. For example, in U.S. Pat. No. 6,892,930 entitled “Process For Reconditioning Worn Or Out-Of-Spec Components,” a replacement partial area is soldered to a worn component, after which the partial area is machined back to the required dimensions. Another option if the part is not to be remade is to replace all mating parts (e.g., the bearings, bushings, piston, or ring) with a modified part designed to mate with the worn part. Thus, for example, a larger piston may accommodate a worn cylinder liner and a decreased diameter bearing may accommodate a worn crankshaft.

However, neither of these solutions is entirely satisfactory. For example, when a part is reconditioned through the addition of material, it can be difficult to reach a uniform hardness throughout the part. Moreover, the joint between new and old material presents a point of failure. With respect to the second method of replacing all mating parts, this requires that the remanufacturer maintain a stock of non-standard sized parts, and that they be stocked in sufficient range to accommodate the entire range of possible wear. This strategy is both expensive and time-consuming.

Thus, it is desirable to have a system that, in some embodiments, may alleviate at least some of the shortcomings of the existing art. However, it will be appreciated that the resolution of deficiencies, noted or otherwise, of the prior art is not a critical or essential limitation of the disclosed principles. Moreover, this background section is presented as a convenience to the reader who may not be of skill in this art. However, it will be appreciated that this section is too brief to attempt to accurately and completely survey the prior art. The preceding background description is a simplified narrative and is not intended to replace the reference being discussed. Therefore, interested readers should refer directly to the referenced patent instead of relying upon the foregoing simplified narrative.

### SUMMARY

The disclosure pertains to a method of selectively redimensioning a ferrous object by identifying a portion of the object to be redimensioned, e.g., a worn location, including less than the entirety of the object. Applying a localized heat source to the worn location, i.e., the portion of the object to be redimensioned, to the substantial exclusion of the remainder of the object causes a selective expansion of the heated material from a first external measurement to a second external measurement along at least one dimension of the object. Adequately quenching the object at this time substantially fixes the selective expansion in the object.

In another aspect, the disclosure pertains to a method of remanufacturing an engine comprising disassembling the engine to retrieve an engine component, measuring the component to identify at least one worn location that is out-of-specification, applying a localized heat source to the worn location causing a local expansion of the component at the worn location, and quenching the component to substantially fix the local expansion of the component. In an aspect, the method may also include machining the component so that the component including the at least one worn location is within specification for the component, and then reassembling the engine including the component.

A further aspect of the disclosure pertains to a reconditioned machine component for remanufacturing a machine. The component comprises a component body, and a component surface surrounding the component body, wherein the component body comprises one or more treated locations comprising a volume (and a portion of the component surface), the volumes of the one or more treated locations having a substantially lower density than the remainder of the component.

### BRIEF DESCRIPTION OF THE DRAWINGS

FIG. 1 is a cross-sectional top view of a cylinder assembly including a piston and associated cylinder within an internal combustion engine;

FIG. 2 is a cross-sectional top view of a cylinder assembly including a piston and associated cylinder within an internal combustion engine, wherein the piston has been worn, wherein the piston is suitable for reconditioning pursuant to the disclosed principles;

FIG. 3 is a cross-sectional top view of a worn piston that has been removed from the internal combustion engine for measurement and reconditioning in keeping with the disclosed principles;

FIG. 4 is a cross-sectional top view of a worn piston that has been removed from the internal combustion engine wherein a localized heat source is being applied to a worn location of the piston;

FIG. 5 is a cross-sectional top view of a worn piston that has been removed from the internal combustion engine and treated cause a local expansion of worn areas;

FIG. 6 is a cross-sectional top view of the worn piston of FIG. 3 wherein the piston has been reconditioned in keeping with the disclosed principles;

FIG. 7 is a two-directional plot of volume versus temperature for a part treated according to the disclosed principles; and

FIG. 8 is a flow chart showing a process of executing a heat treatment process according to the disclosed principles.

### DETAILED DESCRIPTION

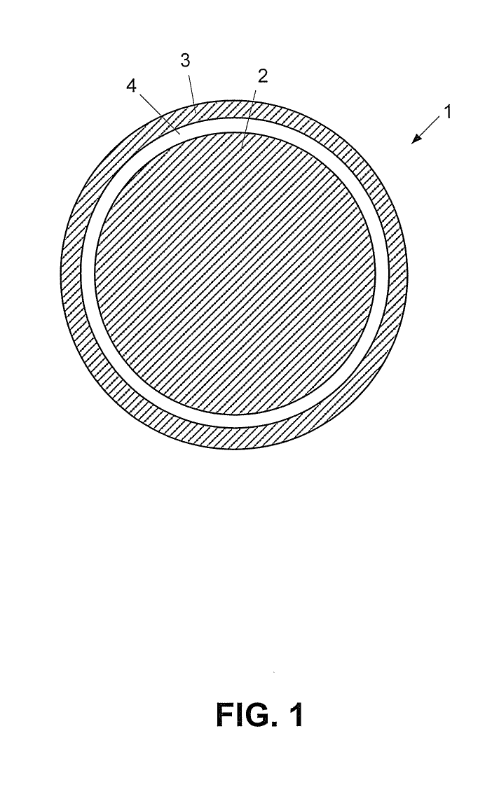

This disclosure relates to a method of selectively redimensioning a ferrous object through a specialized regimen of heat treatment, quenching, and remachining of the object, exploiting certain crystalline properties of ferrous materials. FIG. 1 is a cross-sectional top view of a cylinder assembly 1, such as may be used within an internal combustion engine (not shown). The cylinder assembly 1 includes one or more engine components including a piston 2 (e.g., a ferrous object or part) and an associated cylinder 3 (which may also be a ferrous object or part). As can be seen, the piston 2 and the cylinder 3 are separated by a gap 4 in the unworn condition. This gap 4 is generally designed based on a balance between friction and compression, accounting for the heating characteristics of the materials of the piston 2 and cylinder 3. For example, it is desired that the fit between the piston 2 and cylinder 3 be loose enough that the piston, when properly lubricated, slides freely within the cylinder 3. It will be appreciated that the discussions herein regarding engine cylinders apply whether the cylinder is unitary or only a liner.

At the same time, if the gap 4 is too large, i.e., the fit between the piston 2 and cylinder 3 is too loose, then the gases of combustion within the cylinder 3 may blow past the piston 2, resulting in inefficiency and other problems. Since most materials undergo a temporary expansion while at elevated temperature, the gap 4 is configured so that the fit between the cylinder 3 and piston 2 is proper when the engine is at operating temperature, since this is the state in which the engine will typically spend most of its operating time.

Thus, it will be appreciated that gap 4 has only a small range wherein the fit between the cylinder 3 and piston 2 is optimal. However, as the engine operates, the material of the piston 2 and/or cylinder 3 is worn and\or eroded through friction, oxidation, etc. Thus, after a certain period of operation, the gap 4 may no longer fall within the appropriate operating range. More typically, the gap 4 may become nonuniform, falling within the appropriate operating range about much of the circumference of the piston 2, but falling outside of the range at specific points.

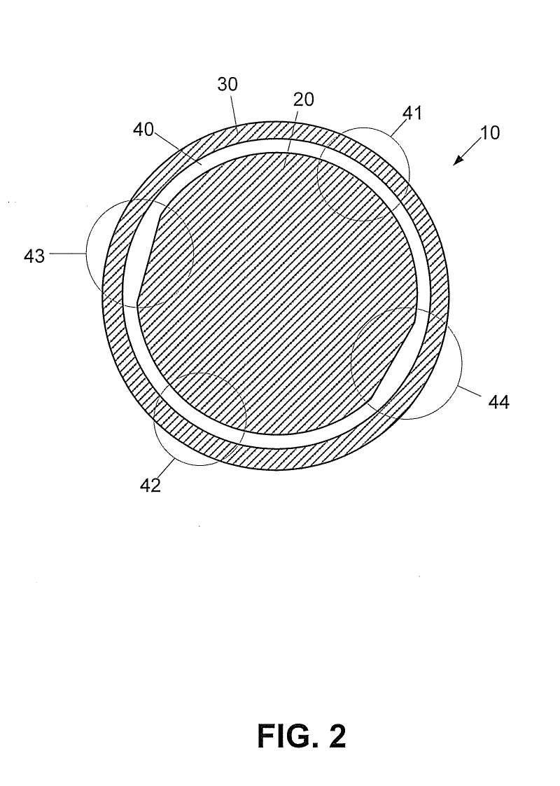

FIG. 2 is a cross-sectional top view of a cylinder assembly 10 including a ferrous piston 20 and associated cylinder 30 within an internal combustion engine (not shown), wherein the piston 20 has been worn and is suitable for reconditioning pursuant to the disclosed principles. In particular, it can be seen that the gap 40 between the piston 20 and cylinder 30 is properly dimensioned at most points around the circumference of the assembly 10, e.g., at first normal location 41 and second normal location 42. However, at a first worn location 43 (or portion) and a second worn location 44 (or portion), the piston 20 has been worn so that the gap 40 between the piston 20 and the cylinder 30 at these locations is excessive. It will be appreciated that the gap 4, 40 and the extent of wear at the first worn location 43 and the second worn location 44 are exaggerated for visibility. In practice, the relevant measurements may or may not be visible to the naked eye.

The uneven wear of the piston 20 can be caused by a number of factors including differences in material composition within the piston 20, contaminants within the engine, and nonuniform forces acting on the piston 20. The later can arise through the action of a connecting rod, an exhaust port, the pull of gravity, etc. Although not shown in the cross-sectional view of FIG. 2, a worn area may exist at only a certain height on the piston 20, or may span the height of the piston 20.

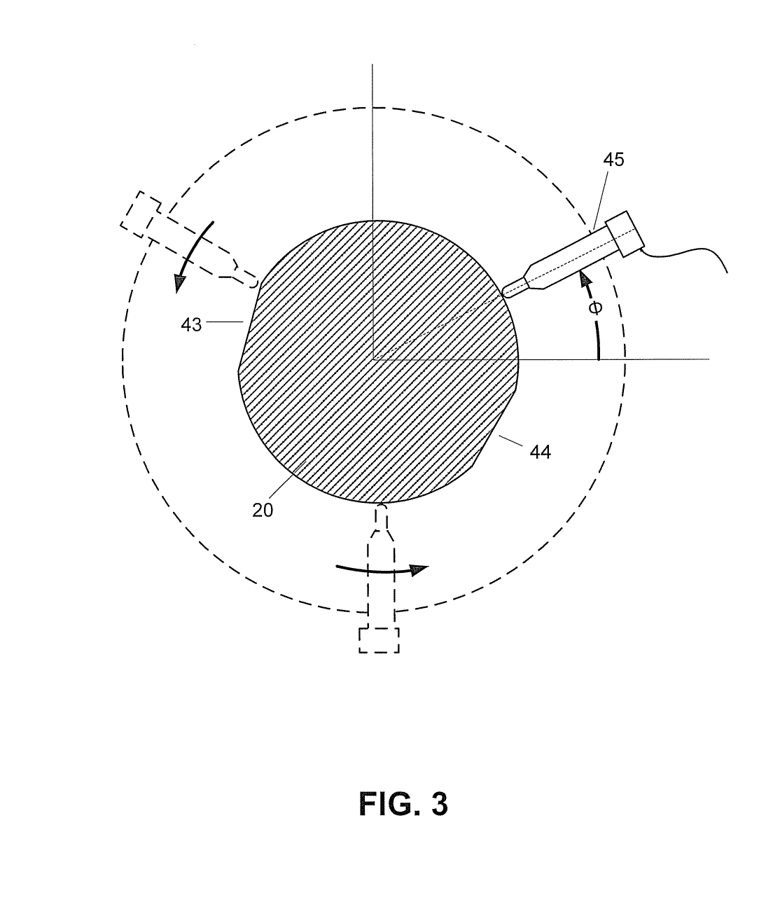

While the operation of the engine may evidence the excessive wear at the first worn location 43 and the second worn location 44, it can be difficult to precisely identify the location of any wear without disassembling the engine and removing the piston 20 from the cylinder 30. Once disassembled, the piston 20 appears as shown in FIG. 3. In particular, FIG. 3 is a cross-sectional top view of a worn piston 20 that has been removed from the internal combustion engine for measurement and reconditioning in keeping with the disclosed principles.

The piston 20 is shown with a surface measurement probe 45 that can circumscribe the piston 20 to detect any worn areas such as the first worn location 43 and the second worn location 44. The surface measurement probe 45 may be a contact probe, as shown, or may be another suitable probe such as an interferometric probe, etc. as will be appreciated by those of skill in the art. The angle Ø of the surface measurement probe 45 about the piston 20 is used to identify respective coordinates for the first worn location 43 and second worn location 44.

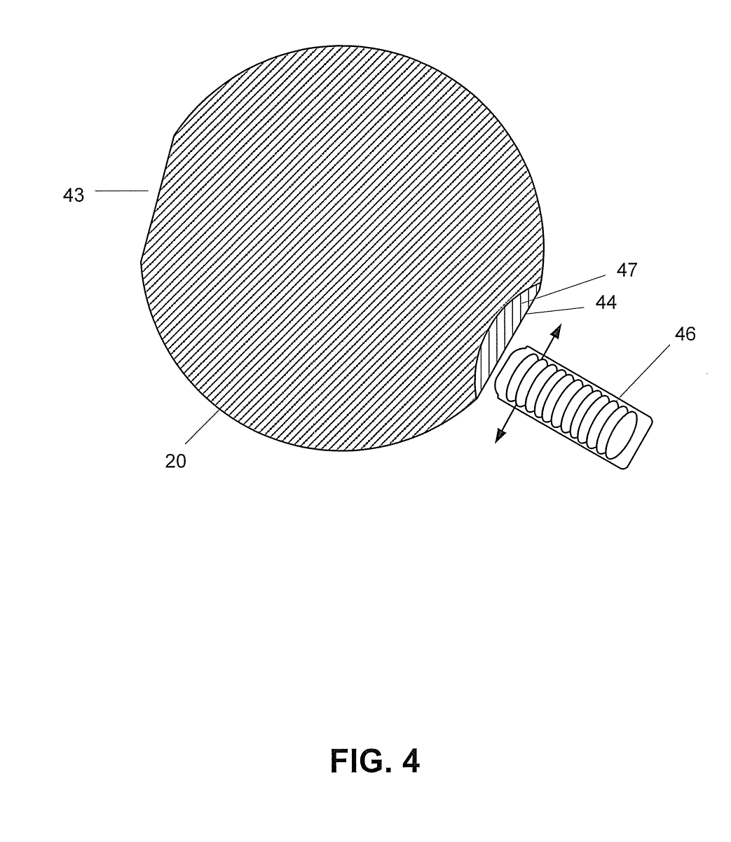

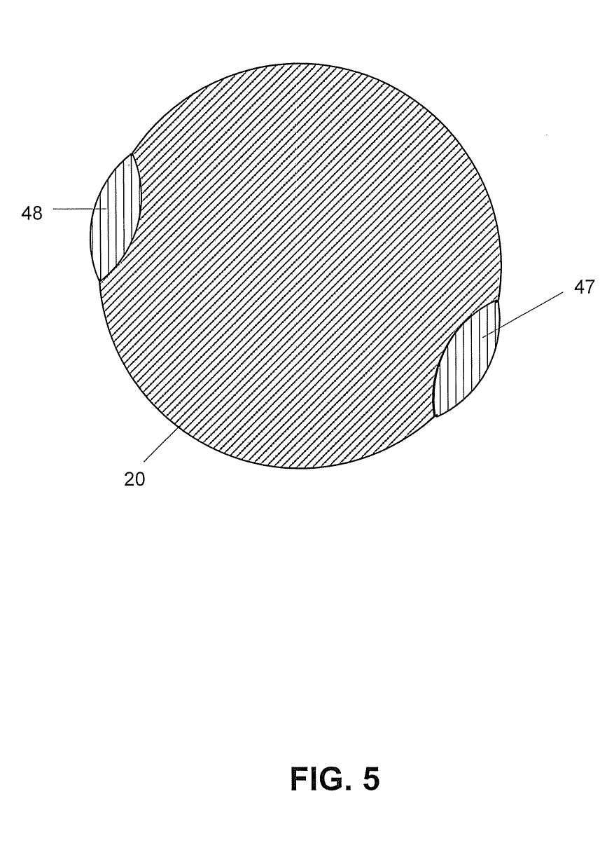

After the coordinates of the first worn location 43 and second worn location 44 have been identified, a localized heat source such as a scanning inductive heater 46 as shown in FIG. 4 is used to selectively heat only the worn locations, i.e., to cause local heating. In the specific illustrated example, the scanning inductive heater 46 is shown heating a surface region 47, i.e., a volume that includes the second worn location 44. When the surface region 47 is heated beyond the austenitic temperature, austenite forms (and is later transformed to martensite upon cooling) within the surface region 47. Because the martensite occupies a greater volume (is of a lower density) than the material it replaces, surface region 47 expands as shown in FIG. 5. The size change has two components. The primary component is the austenite/martensitic transformation, however there may also be expansion due to local plasticity caused by temperature gradients and inhomogeneous thermal expansion. The surface region 47 is then quenched to prevent annealing and complete the transformation of austenite to martensite, locking the surface region 47 in the expanded state even at room temperature as shown in FIG. 5. A similar process is carried out at surface region 48, which includes the first worn location 43, to produce a second expanded area.

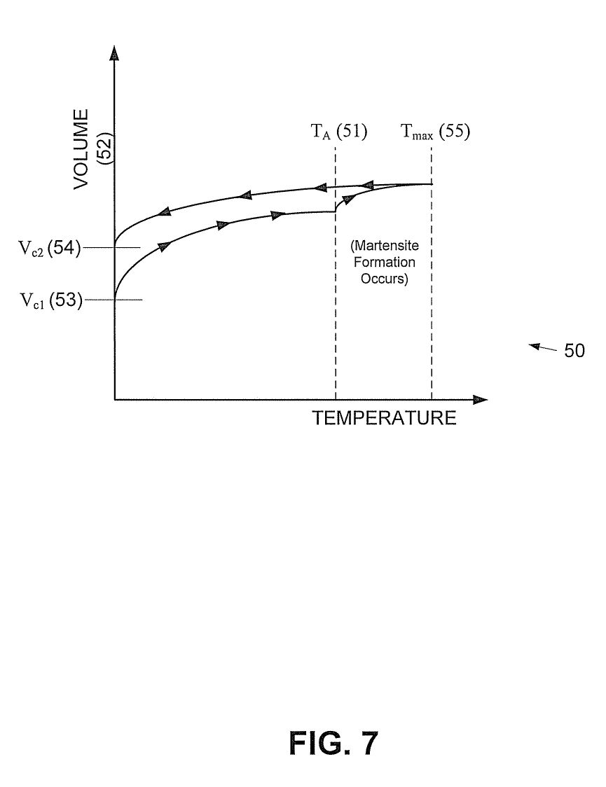

The chart 50 of FIG. 7 illustrates the volume of a region such as surface region 48 during the heating cycle. At temperatures below the austenitic temperature T_{A} 51, the volume 52 of the surface region 48 reacts, e.g., expands, thermally. After the austenitic temperature 51 has been reached, the volume 52 of the surface region 48 expands again due to the formation of austenite (which will quench to martensite) within the surface region 48. The degree of volume change associated with martensite formation can be approximately 1% of the pre-treatment cold volume V_{c1} 53 of the surface region 48. The temperature may be raised to a final temperature Tₘₐₓ 55 and held for a predetermined period of time, e.g., one minute, or more or less.

After sufficient austenite formation has occurred, the surface region 48 is quenched quickly to complete the transformation of austenite to martensite. In this manner, the post-treatment cold volume V_{c2} 54 of the surface region 48 is greater than the pre-treatment cold volume V_{c1} 53 of the surface region 48. The quench mechanism may be via one of, or a plurality of, water, steam, and mist, or other quench medium as will be appreciated by those of skill in the art. In an alternative embodiment, the mass quenching of the piece is used instead of external quenching. In partitcular, some pieces have sufficient mass to quickly dissipate heat from the treated area without the use of an external quenching medium.

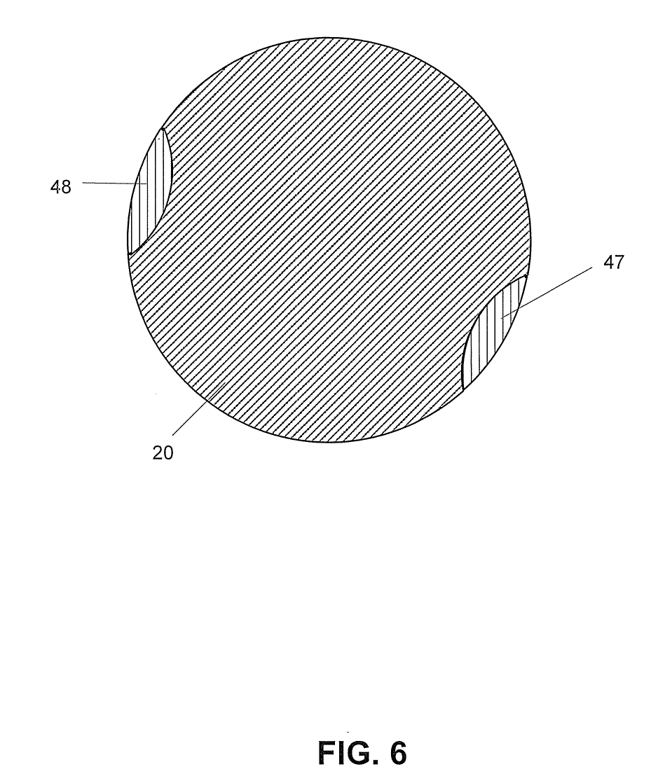

Once the piston 20 has been expanded beyond tolerance at surface region 47 and surface region 48, it is machined as shown in FIG. 6 so that the piston 20 meets required tolerances or dimensions at surface region 47 and surface region 48. The piston 20 may be optionally rechecked in the same manner shown in FIG. 3 or otherwise to ensure that the piston 20 is within tolerance and suitable for use.

Although the examples above illustrate a technique for remanufacturing a piston 20, it will be appreciated that the illustrated technique applies as well to any part made of a ferrous material such as hardened steel or cast iron, e.g., bushings, cylinders, cylinder liners, etc. However, it is generally even more effective to use the technique on surface-hardened components such as a cylinder 30 or a piston 20, rather than through-hardened components such as wrist pins, since the heat expansion cycle may affect the structural strength of a through-hardened piece. Nonetheless, if desired, the technique may be applied to through-hardened pieces as well.

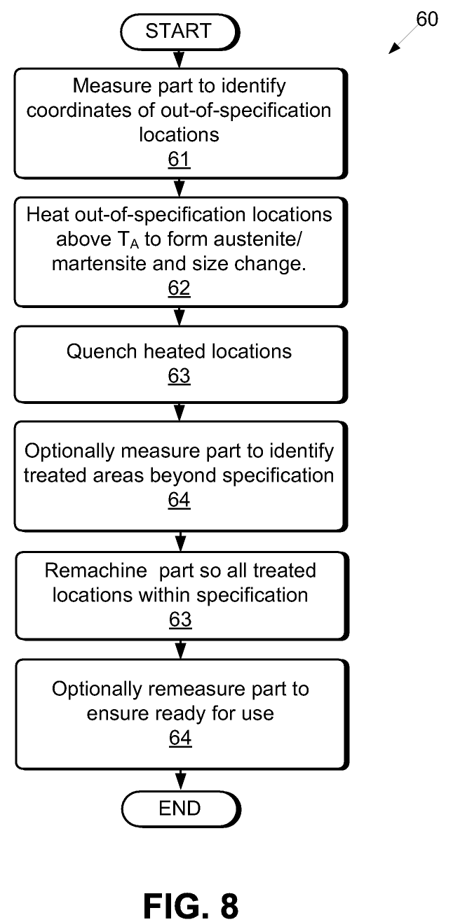

For clarity, an embodiment of the foregoing process is succinctly described via the process 60 represented in the flow chart of FIG. 8, with respect to a generic part, which includes a part such as piston 20, cylinder 30 or any other part. At stage 61 of the process 60, the part is measured to identify the coordinates of any locations that are out of specification. As noted above, this may be accomplished via any sort of measurement technology, be it contact sensing, interferometric sensing, etc.

At stage 62 of the process 60, the identified coordinates of the locations that are out of specification are used to heat the locations that are out of specification to above the austenitic temperature of the part in order to expand the part at those locations via the formation of martensite. The heating of multiple worn locations may be executed serially (in which case quenching would be accomplished sequentially as well) or in parallel. The heating source is inductive in an embodiment, but may optionally be any other suitable source such as a flame, arc, plasma, etc., as will be appreciated by those of skill in the art. In the case of an inductive heater, the heater may be water cooled in an embodiment.

After the part has been expanded at the appropriate locations, the heated locations are quenched at stage 63 in order to fix the part, and in particular the treated locations, in their martensitic, i.e., expanded, state. At stage 64, the part is optionally measured to determine whether the expanded locations are within specification or are out of specification. Alternatively, it may be assumed that the locations are out of specification.

At stage 65, the part is remachined so that all portions, including the treated locations, are within specification. It will be appreciated that the treated locations are hardened, as may be the rest of the part, and appropriate care should be taken when machining the part back into specification. At stage 66, the part is optionally remeasured to ensure that the part is within specification and ready for reuse. After treatment, the part may be further processed metallurgically as appropriate for the intended use. For example, the part may be deep-hardened or annealed after treatment and prior to use.

### INDUSTRIAL APPLICABILITY

The present disclosure is applicable to the remanufacture of ferrous metal parts, such as those made of hardened steel and cast iron. Typically, metal parts used in high-stress applications, such as engines or other thermally, chemically, and/or mechanically stressed environments, undergo a degree of wear that renders them unsuitable for use after exyended use. Generally, it is less expensive to remanufacture the piece of equipment rather than purchase a new piece of equipment. However, the worn parts may be out of tolerance, and hence may be unusable. The present technique allows the parts to be returned to specification without adding material to the part and without having to use non-specification mating parts to accommodate for the wear.

In various embodiments, the crystalline phase change of heated ferrous materials is used to expand worn areas to within or beyond the relevant specifications, so that the part may then be machined into specification and reused. The expansion due to this phase change is locked into the material of the part via quenching after heating of selected locations beyond the material's austenitic temperature.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of selectively redimensioning a ferrous object comprising:
identifying a portion of the ferrous object to be redimensioned, wherein the portion of the object to be redimensioned includes less than the entirety of the object;
applying a localized heat source to the portion of the object to be redimensioned, to the substantial exclusion of the remainder of the object, thereby causing a selective expansion of the heated material from a first external measurement to a second external measurement along at least one dimension of the object; and
quenching the object to substantially fix the selective expansion in the object.

2. The method according to claim 1, wherein the ferrous object is composed at least in part of cast iron.

3. The method according to claim 1, wherein the ferrous object is composed at least in part of steel.

4. The method according to claim 1, wherein applying a localized heat source to the portion of the object to be redimensioned comprises applying heat from an inductive heater to the portion of the object.

5. The method according to claim 1, wherein quenching the object comprises applying a quenching medium to the object, the quenching medium including at least one of water, steam, and mist.

6. The method according to claim 1, wherein quenching the object comprises allowing the mass of the object to quench the portion of the object to be redimensioned without applying a quenching medium to the object.

7. The method according to claim 1, further comprising machining the object after quenching the object.

8. The method according to claim 7, further comprising deep-hardening the object after machining the object.

9. The method according to claim 7, further comprising annealing the object after machining the object.

10. The method according to claim 7, further comprising measuring the object after machining the object to identify any portion of the object that is not within specification.

11. A method of remanufacturing an engine comprising:
disassembling the engine to retrieve an engine component from within the engine, the component having a component surface;
measuring the component to identify at least one worn location on the component that is out-of-specification for the component, the at least one worn location including less than the entirety of the component surface;
applying a localized heat source to the at least one worn location, to the substantial exclusion of the remainder of the component surface, thereby causing a local expansion of the component at the at least one worn location;
quenching the component to substantially fix the local expansion of the component;
machining the component so that the component including the at least one worn location is within specification for the component; and
reassembling the engine including the component.

12. The method according to claim 11, wherein the component is one of an engine cylinder and an engine piston.

13. The method according to claim 11, wherein the component is composed at least in part of one of cast iron and hardened steel.

14. The method according to claim 11, wherein applying a localized heat source to the at least one worn location comprises applying heat from an inductive heater to the at least one worn location.

15. The method according to claim 11, wherein quenching the component comprises applying a quenching medium to the at least one worn location, the quenching medium including at least one of water, steam, and mist.

16. The method according to claim 11, further comprising performing one of deep-hardening the component and annealing the component after machining the component.

17. The method according to claim 11, further comprising measuring the component after machining the component to identify any portion of the component that is not within specification.

18. A reconditioned machine component for remanufacturing a machine, the component comprising:
a component body; and
a component surface surrounding the component body, wherein the component body comprises one or more treated locations, each treated location comprising a volume including a portion of the component surface, the volumes of the one or more treated locations having a substantially lower density than the remainder of the component.

19. The reconditioned machine component according to claim 18, wherein the volumes of the one or more treated locations have a substantially higher concentration of martensite than the remainder of the component.

20. The reconditioned machine component according to claim 18, wherein the reconditioned machine component is one of a piston and a cylinder.
